(19) United States
(12) Patent Application Publication
(10) Pub. No.: US 2026/0192991 A1
(43) Pub. Date: Jul. 9, 2026

(54) DISPENSING DEVICE WITH FLOW REGULATOR

(71) Applicant: GRM TEK, LLC, Ocala, FL (US)

(72) Inventors: Andrew Christopher Michaud, Bradenton, FL (US); Austin Christopher Reed, Ocala, FL (US)

(21) Appl. No.: 19/012,134

(22) Filed: Jan. 7, 2025

(51) Int. Cl. B65D 47/10; B65D 83/00

(52) U.S. Cl. CPC B65D 47/10; B65D 83/00

(57) ABSTRACT

A dispensing device has a tamper resistant enclosure with a primary space containing a first chemical and a flow regulator with a migration pathway in flow communication with the enclosure. The flow regulator is configured to generate a pressure differential between the migration pathway and the primary space to evacuate the enclosure at least partially through an exit pathway. A secondary space may contain a second chemical to be mixed or combined with the first chemical. A primary frangible seal is disposed between the primary space and the flow regulator, and a second frangible seal is disposed between the primary space and the secondary space. The flow regulator may include a priming chamber or a bypass pathway with a one-way valve to create a pressure differential upon breaking the primary frangible seal.

### CROSS REFERENCE TO RELATED APPLICATIONS

N/A

### BRIEF DESCRIPTION OF THE DRAWINGS

FIG. 1 is a cutaway schematic of one embodiment of a dispensing device having a flow regulator with a priming pathway.

FIG. 2 is a cutaway schematic another embodiment of dispensing device having a flow regulator without a priming pathway.

FIG. 3 is a cutaway schematic of yet another embodiment of a dispensing device having a flow regulator with a priming chamber.

FIG. 4 is a cutaway schematic of yet another embodiment of a dispensing device having a flow regulator with a dispensing needle and a pressure sensitive bypass valve.

FIG. 5 is a cutaway schematic of the flow regulator of the dispensing device shown in FIG. 3.

FIG. 6 is a cutaway schematic of the flow regulator feature of the dispensing device shown in FIG. 4.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following description, for the purposes of explanation, numerous specific details are set forth in order to provide a thorough understanding of the present invention. It will be apparent, however, to one skilled in the art that the invention may be practiced without some of these specific details. Throughout this description, the embodiments and examples shown should be considered as exemplars, rather than as limitations on the invention. That is, the following description provides examples, and the accompanying drawings show numerous examples for the purposes of illustration. However, these examples should not be construed in a limiting sense as they are merely intended to provide examples of the invention rather than to provide an exhaustive list of all possible implementations of the invention.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention. In addition, reference throughout this specification to “one embodiment” “some embodiments” or “an embodiment” means that a particular feature, structure, or characteristic described in connection with the embodiment is included in at least one embodiment of the present invention. Thus, appearances of the phrases “in one embodiment” “in some embodiments” or “in an embodiment” in various places throughout this specification are not necessarily all referring to the same embodiment. Furthermore, the particular features, structures or characteristics may be combined in any suitable manner in one or more embodiments.

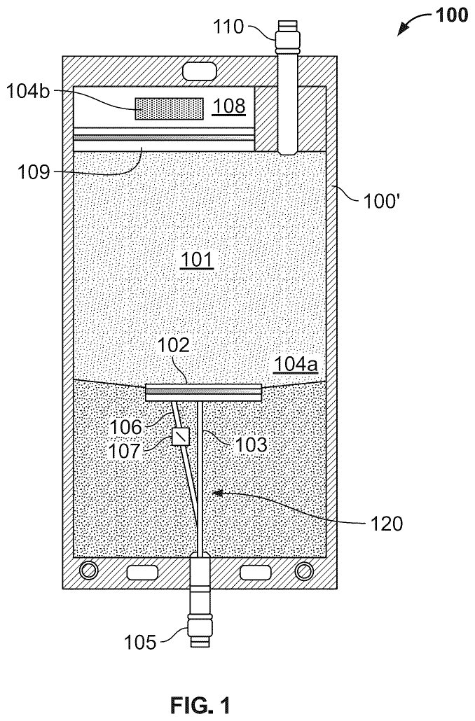

Referring to FIG. 1, shown is a dispensing device 100 comprising a tamper resistant enclosure 100′. The enclosure 100′ delimits a primary space 101 sealed by a primary frangible seal 102. With the primary frangible seal 102 activated (for example, broken by manual force applied to the enclosure 100′ at or about the region surrounding the seal 102), the primary space 101 is in flow communication with a flow regulator 120 comprising a migration pathway 103, a priming pathway 106, and a one-way valve 107. In some embodiments, the flow regulator 120 is disposed completely inside the enclosure 100′ of the device. The migration pathway 103 is bypassed by a priming pathway 106 controlled by a one-way valve 107 to prime chemical 104a into the exit pathway 105. Upon activation, a pressure differential is created between the migration pathway 103 and the primary space 101 such that a chemical 104a otherwise contained in the primary space 101 is dispensed from the device 100 at a predetermined rate through the flow regulator 120 and out through the exit pathway 105. Accordingly, the flow regulator 120 functions to at least partially evacuate the primary space 101 by generating a pressure differential between the migration pathway 103 and the primary space 101. In some embodiments, the pressure differential may be negative such that the air pressure in the migration pathway is less than that inside of the primary space 101.

In some embodiments, chemical 104a (in the case, a first chemical) is augmented by a second chemical 104b which resides in secondary space 108 separated from primary space 101 by secondary frangible seal 109. In some embodiments, secondary frangible seal 109 is activated first, thereby causing the second chemical 104b to mix with the first chemical 104a, and then primary frangible seal 102 is activated in order to at least partially evacuate the primary space 101 and dispense the mixture out of device 100 through the exit pathway 105.

In one non-limiting example, the second chemical 104b is a solute and the first chemical 104a is a solvent to enable the reconstitution of a target chemical through the activation and mixing procedure described. In other embodiments, the second chemical 104b is introduced from an external source into to the primary space 101 (or secondary space 108) through injection port 110. For example, the first chemical 104a may be a dilutant into which the second chemical 104b is introduced through injection port 110, which injection port 110 is in flow communication with either or both of the primary space 101 and secondary space 108.

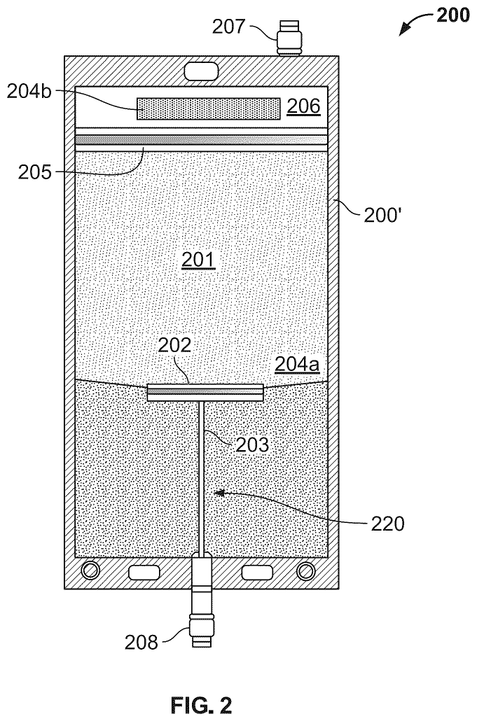

FIG. 2 is an alternative embodiment of the invention shown in FIG. 1, without the priming pathway. Shown is a dispensing device 200 comprising a tamper resistant enclosure 200′. The enclosure 200′ delimits a primary space 201 seal by a primary frangible seal 202. With the primary frangible seal 202 activated (for example, broken by manual force applied to the enclosure 200′ at or about the region surrounding the seal 202), the primary space 201 is in flow communication with a flow regulator 220 comprising a migration pathway 203. In some embodiments, the flow regulator 220 is disposed completely inside the enclosure 200′ of the device. Upon activation, a chemical 204a is dispensed from the device 200 at a predetermined rate through the exit pathway 208, which exit pathway 208 is in flow communication with the flow limited migration pathway 203. Accordingly, the flow regulator 220 functions to at least partially evacuate the primary space 201.

In some embodiments, chemical 204a (in the case, a first chemical) is augmented by second chemical 204b which resides in secondary space 206 separated from primary space 201 by secondary frangible seal 205. In some embodiments, secondary frangible seal 205 is activated first, thereby causing the second chemical 204b to mix with the first chemical 204a, and then primary frangible seal 202 is activated in order to at least partially evacuate the primary space 201 and dispense the mixture through the migration pathway 203 and out of device 200 through the exit pathway 208.

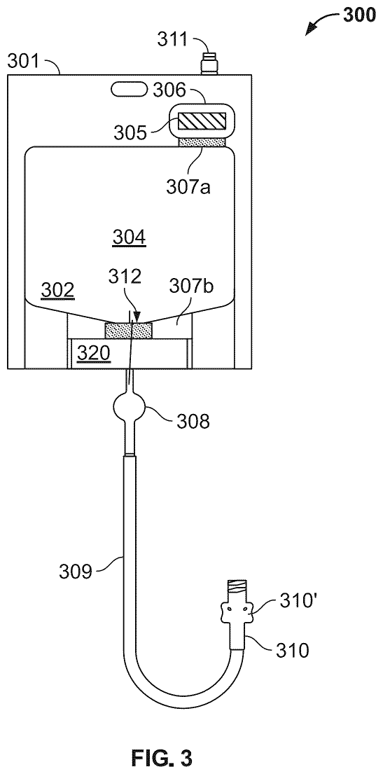

Referring to FIG. 3, shown is an embodiment of a dispensing device 300 comprising a tamper resistant enclosure 301. In some embodiments, the device 300 has a primary space 304, a secondary space 306, an injection port 311, and frangible seals 307a and 307b. Secondary frangible seal 307a occludes the secondary space 306 and primary frangible seal 307b occludes the primary space 304 such that, in an un-activated state, the primary space 304 is sealed externally and from the secondary space 306. With at least the primary frangible seal 307b activated (for example, broken by manual force applied to the enclosure 301 at or about the region surrounding the seal 307b), the primary space 304 is in flow communication with a flow regulator 320. The flow regulator 320 delimits a migration pathway 312 and includes a priming chamber 308. The flow regulator 320 is in flow communication with tubing 309, which is distal of the priming chamber 308, a connector 310 at the distal end of the tubing 309. The flow regulator 320 functions to at least partially evacuate the primary space 304.

In some embodiments, the primary space 304 contains a first chemical 302 and the secondary space 306 contains a second chemical 305. In some embodiments, the secondary space 306 is separated from the primary space 304 by a secondary frangible seal 307a. With at least the secondary frangible seal 307a activated (for example, broken by manual force applied to the enclosure 301 at or about the region surrounding the seal 307a), the device enables reconstitution of a target chemical by mixing or combining the second chemical 305 comprising a solute and the first chemical 302 comprising a solvent. In other embodiments, the secondary space 306 includes an injection port 311 to allow the second chemical 305 to be introduced into the primary space 304 (or secondary space 306) to be mixed with a dilutant the first chemical 302, which may be a dilutant. Accordingly, the injection port 311 is in flow communication with either or both of the primary space 304 and the secondary space 306.

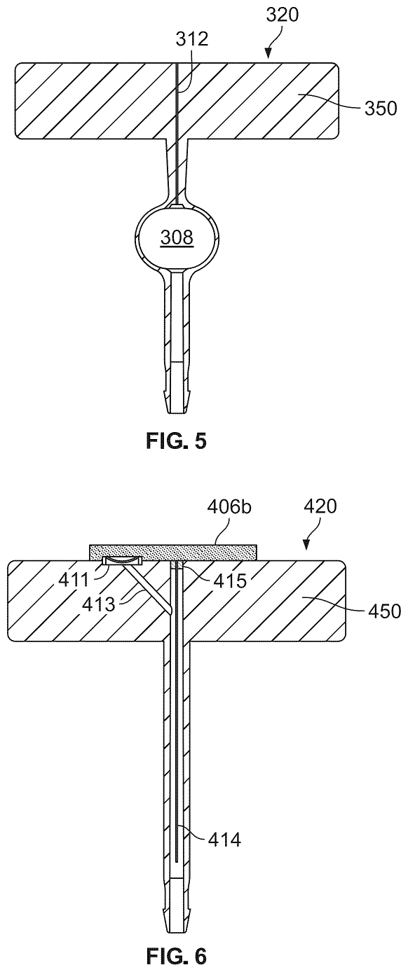

With reference to both FIGS. 3 and 5, in some embodiments, the migration pathway 312 of the flow regulator 320 is disposed inline between the priming chamber 308 and the primary space 304, distal of the primary frangible seal 307b. The migration pathway 312 in some embodiments is initially occluded by the primary frangible seal 307b. In some embodiments, the primary frangible seal 307b is designed to burst only when user intends to activate the device 300. The flow regulator 320 modulates the outward flow at a predetermined rate through the priming chamber 308. The flow regulator 320 is activated by compressing priming chamber 308. In some embodiments, after compression, air will exit the priming chamber 308 into migration pathway 312 breaking primary frangible seal 307b. The target chemical (which may be a mixture of the first chemical 302 and second chemical 305) is drawn into the expanding priming chamber 308 by the resultant pressure differential. The target chemical will then flow through tubing 309 and exit via connector 310, which is the distal terminus of flow.

In some embodiments connector 310 comprises includes a cap or one-way check valve 310′, for example a duckbill valve. Inclusion of a check valve 310′ downstream of the priming chamber 308 may serve to prevent backflow back into enclosure 301 and will maximize initial backpressure created by compressing priming chamber 308 and, therefore, maximize the subsequent pressure differential that draws the target chemical out of the primary space 304 through flow regulator 320. In some embodiments, the flow regulator 320 includes a flange 350 that is attached to the bottom of the enclosure 301, for example by heat sealing or adhesives. Accordingly, in some embodiments, the flow regulator 320 is partially disposed in the enclosure 301.

In some embodiments, the first and second chemicals 302 and 305 are mixed or combined prior to dispensing. For example, the user will first compress secondary space 306, which contains second chemical 305 and, in some cases, air. This will burst secondary frangible seal 307a creating a pathway for second chemical 305 to enter primary space 304 containing the first chemical 302. The user will then compress priming chamber 308 to dispense the mixture out of the device 300.

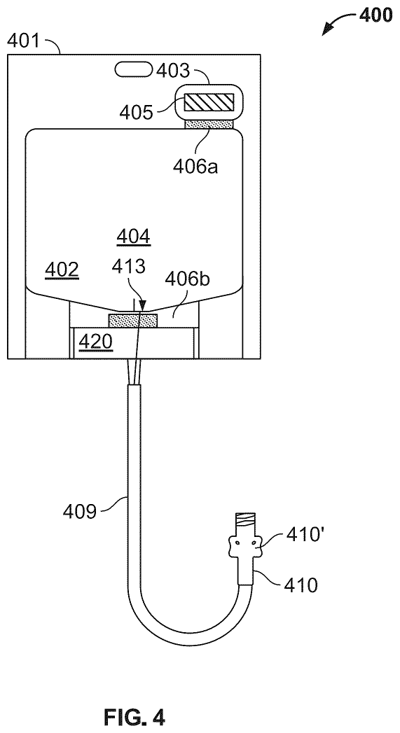

Referring to FIGS. 4 and 6, shown is an embodiment of a dispensing device 400 comprising a tamper resistant enclosure 401. In some embodiments, the device 400 has a secondary space 403, a primary space 404, and frangible seals 406a and 406b. Secondary frangible seal 406a occludes the secondary space 403 and primary frangible seal 406b occludes the primary space 404 such that, in an un-activated state, the primary space 404 is sealed externally and from the secondary space 403.

In some embodiments, the primary space 404 contains a first chemical 402 and the secondary space 403 contains a second chemical 405. In some embodiments, the secondary space 403 is separated from the primary space 404 by the secondary frangible seal 406a. With at least the secondary frangible seal 406a activated (for example, broken by manual force applied to the enclosure 401 at or about the region surrounding the seal 406a), the device enables reconstitution of a target chemical by mixing or combining the second chemical 405 comprising a solute and the first chemical 402 comprising a solvent. In other embodiments, the secondary space 403 includes the injection port 311 (see FIG. 3) to allow the second chemical 405 to be introduced into the secondary space 403 to be mixed with a dilutant the first chemical 402, which may be a dilutant.

With at least the primary frangible seal 406b activated (for example, broken by manual force applied to the enclosure 401 at or about the region surrounding the seal 406b), the primary space 404 is in flow communication with a flow regulator 420. The flow regulator 420 is in flow communication with tubing 409 and a connector 410. The flow regulator 420 comprises a migration pathway 413, dispensing needle 414, a hub 415, and a pressure sensitive bypass valve 411. This flow regulator enables dispensing in a single step. The migration pathway 413 is disposed through the flow regulator 420 and is in flow communication with the primary space 404 of the device 400. The migration pathway 413 is initially occluded by the primary frangible seal 406b. The user will compress primary space 404 which bursts primary frangible seal 406b. The target chemical (comprising either first chemical 402 or a combination or mixture of first chemical 402 and second chemical 405) will first flow through pressure sensitive valve 411 because it will have a lower pressure threshold to overcome. The target chemical will flow through migration pathway 413 past dispensing needle 414 creating a Venturi effect. This will create a sufficient pressure differential to draw the target chemical through dispensing needle 414 without the need to further compress the primary space 404. Valve 411 will subsequently close, and the target chemical will continue to flow through dispensing needle 414 at predetermined rate into tubing 409, exiting via connector 410. Accordingly, the flow regulator 420 functions to at least partially evacuate the primary space 404. In some embodiments connector 410 comprises includes a cap or one-way check valve 410′, for example a duckbill valve, with the benefits as described above. In some embodiments, the flow regulator 420 includes a flange 450 that is attached to the bottom of the enclosure 401, for example by heat sealing or adhesives. Accordingly, in some embodiments, the flow regulator 420 is partially disposed in the enclosure 401.

In some embodiments, the first and second chemicals 402 and 405 are mixed or combined prior to dispensing. For example, the user will first compress secondary space 403, which contains second chemical 405 and, in some cases, air. This will burst secondary frangible seal 406a creating a pathway for second chemical 405 to enter primary space 404 containing the first chemical 402. The user will then engage the dispensing step described in the preceding paragraph.

In some embodiments, the enclosure of the device (in its various embodiments described herein) is formed from materials which may prevent the leakage of the materials and chemicals contained within the enclosure, such materials including, for example, polyethylene terephthalate (PET, PETE), low density polyethylene (LDPE), linear low-density polyethylene (LLDPE), polypropylene (PP), polyolefin, and non-PVC soft packaging.

It is appreciated and understood that the dimensions of migration pathway and other components of the flow regulator (in its various embodiments described and contemplated herein) can be varied in order to modulate and control the ultimate evacuation flow rate.

It is appreciated and understood that the dispensing device can be used in a wide variety of applications and with a wide variety of material and chemicals to combine and dispense target materials and chemicals into the surrounding environment. It is also noted that the present invention can be used to combine chemical but not necessarily in a manner that cause a chemical reaction. Thus, the device and related methods of administration can be used for combining materials or chemicals and/or providing a means and mechanism for chemically reacting materials or chemicals. In the configurations and methods disclosed, it is apparent that combining or reacting can be accomplished passively, that is without the need for electronics or power supplies, but rather through principals of pressure differentials and fluid mechanics.

It is further appreciated and understood that the invention and related methodology is compatible with chemicals of multiple and varied states of matter including solids, liquids, and gases. For example, liquids may include gels and other aqueous solutions and solids may include powders, concentrates, or aggregates. It is also understood that chemicals of different states can be combined (whether to cause a reaction or otherwise), for example a first chemical can be a liquid and a second chemical can be a solid, resulting in a target chemical being a liquid or gas admixture. In this sense, the state of the chemicals used is non-limiting in the context of this disclosure.

Applications include pharmaceuticals, nutraceuticals, sanitation, food preservation, fumigation, odor control, pest control (pesticides or insecticides), growth control (herbicides), animal attractants or deterrents, pheromone imitation, bio-stimulants, and plant growth regulators or inhibitors.

It is to be noticed that the term “comprising,” used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B. Put differently, the terms “including,” “comprising” and variations thereof mean “including but not limited to,” unless expressly specified otherwise.

Similarly, it is to be noticed that the term “coupled,” also used in the claims, should not be interpreted as being limitative to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The enumerated listing of items does not imply that any or all of the items are mutually exclusive, unless expressly specified otherwise. The terms “a,” “an” and “the” mean “one or more,” unless expressly specified otherwise.

Elements of the invention that are in communication with each other need not be in continuous communication with each other, unless expressly specified otherwise. In addition, elements of the invention that are in communication with each other may communicate directly or indirectly through one or more other elements or other intermediaries.

One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that any alternatives, modifications, permutations, and variations will become apparent to those of ordinary skill in the art in light of the foregoing description. Accordingly, it is intended that the present invention embrace all such alternatives, modifications and variations as fall within the scope of the appended claims. The fact that a product, process, or method exhibits differences from one or more of the above-described exemplary embodiments does not mean that the product or process is outside the scope (literal scope and/or other legally-recognized scope) of the following claims.

What is claimed is:

1. A dispensing device, comprising:
an enclosure delimiting a primary space;
a flow regulator having a migration pathway in flow communication with the primary space; and
wherein the flow regulator is enabled to generate a pressure differential between the migration pathway and the primary space to at least partially evacuate the primary space through an exit pathway.

2. The dispensing device of claim 1, wherein the flow regulator includes a priming pathway having a one-way valve, wherein the migration pathway is bypassed by the priming pathway, and wherein the one-way valve is enabled to generate a pressure differential between the migration pathway and the primary space to at least partially evacuate the primary space.

3. The dispensing device of claim 1, wherein the flow regulator includes a priming chamber in flow communication with the migration pathway, wherein compressing the priming chamber is enabled to generate a pressure differential between the migration pathway and the primary space to at least partially evacuate the primary space.

4. The dispensing device of claim 3, including a frangible seal disposed between the primary space and the flow regulator and wherein the priming chamber is enabled to break the frangible seal upon compression and generate a pressure differential between the migration pathway and the primary space to at least partially evacuate the primary space.

5. The dispensing device of claim 1, wherein the flow regulator includes a migration pathway, a dispensing needle, a hub, and a pressure sensitive bypass valve, wherein the migration pathway is in flow communication with the primary space and wherein the needle is enabled to generate a pressure differential between the migration pathway and the primary space to at least partially evacuate the primary space.

6. The dispensing device of claim 1, wherein a frangible seal is disposed between the primary space and the flow regulator.

7. The dispensing device of claim 1, wherein the enclosure includes a secondary space and a frangible seal disposed between the secondary space and the primary space.

8. The dispensing device of claim 1, wherein the enclosure includes an injection port in flow communication with the primary space.

9. The dispensing device of claim 1, wherein the flow regulator is disposed completely inside the enclosure.

10. The dispensing device of claim 1, wherein the flow regulator includes a flange that is attached to the enclosure such that the flow regulator is partially disposed in the enclosure.

11. A dispensing device, comprising:
an enclosure delimiting a primary space and a secondary space;
a flow regulator having a migration pathway in flow communication with the primary space;
a first frangible seal disposed between the primary space and the flow regulator;
a second frangible seal disposed between the primary space and the secondary space;
wherein the flow regulator includes a priming pathway having a one-way valve, wherein the migration pathway is bypassed by the priming pathway, and wherein the one-way valve is enabled to generate a pressure differential between the migration pathway and the primary space to at least partially evacuate the primary space through an exit pathway.

12. The dispensing device of claim 11, wherein the enclosure includes an injection port in flow communication with the primary space.

13. The dispensing device of claim 11, wherein the flow regulator is disposed completely inside the enclosure.

14. The dispensing device of claim 11, wherein the flow regulator includes a flange that is attached to the enclosure such that the flow regulator is partially disposed in the enclosure.

15. A method of dispensing a target chemical from a dispensing device, comprising:
providing the dispensing device, the dispensing device including an enclosure delimiting a primary space containing the target chemical, a flow regulator having a migration pathway in flow communication with the primary space, and a primary frangible seal disposed between the primary space and the flow regulator;
breaking the primary frangible seal such that the flow regulator generates a pressure differential between the migration pathway and the primary space to at least partially dispense the target chemical from the primary space through an exit pathway.

16. The method of claim 15, wherein the flow regulator includes a priming pathway having a one way valve, wherein the migration pathway is bypassed by the priming pathway, and wherein upon breaking the primary frangible seal the one way valve to generates a pressure differential between the migration pathway and the primary space to at least partially dispense the target chemical from the primary space through the exit pathway.

17. The method of claim 15, wherein the flow regulator includes a priming chamber in flow communication with the migration pathway, and wherein compressing the priming chamber breaks the primary frangible seal and generates a pressure differential between the migration pathway and the primary space to at least partially dispense the target chemical from the primary space through the exit pathway.

18. The method of claim 15, wherein the flow regulator includes a migration pathway, a dispensing needle, a hub, and a pressure sensitive bypass valve, wherein the migration pathway is in flow communication with the primary space and wherein upon breaking the primary frangible seal, the target chemical flows through the migration pathway and past the needle which generates a pressure differential between the migration pathway and the primary space to at least partially dispense the target chemical from the primary space through the exit pathway.

19. The method of claim 15,
wherein the primary space initially contains a first chemical;
wherein the enclosure includes a secondary space initially containing a second chemical;
wherein a secondary frangible seal is disposed between the secondary space and the primary space; and
further including the step of: prior to breaking the primary frangible seal, breaking the secondary frangible seal in order to combine the first chemical and the second chemical to form the target chemical.

20. The method of claim 15,
wherein the primary space initially contains a first chemical;
wherein the enclosure includes an injection port in flow communication with the primary space; and
further including the step of: prior to breaking the primary frangible seal, introducing a second chemical into the primary space through the injection port in order to combine the first chemical and the second chemical to form the target chemical.
